(19) United States
(12) Patent Application Publication
(10) Pub. No.: US 2021/0047166 A1
(43) Pub. Date: Feb. 18, 2021

(54) SYSTEM FOR MONITORING GAS LEVEL IN A GAS STORAGE CYLINDER

(71) Applicant: BILLI AUSTRALIA PTY LTD, Thomastown (AU)

(72) Inventor: Lynton McKAY, ThomasTown (AU)

(73) Assignee: Billi Australia Pty Ltd, Thomastown (AU)

(21) Appl. No.: 16/977,243

(22) PCT Filed: Feb. 26, 2019
(86) PCT No.: PCT/AU2019/050159

§ 371 Date: Sep. 1, 2020

(30) Foreign Application Priority Data
Mar. 2, 2018 (AU) 2018900676

(51) Int. Cl. B67D 1/00; G01F 23/20; B67D 1/04; F17C 13/02; B01F 3/04; B01F 15/00

(52) U.S. Cl. CPC B67D 1/0069; B01F 2215/0022; B67D 1/0406; F17C 13/023; B01F 3/04808; B01F 15/00194; B01F 15/00305; B67D 2001/0092; B67D 2001/0098; F17C 2201/0109; F17C 2201/032; F17C 2205/0329; F17C 2205/0338; F17C 2221/013; F17C 2223/0123; F17C 2223/036; F17C 2250/032; F17C 2250/0421; F17C 2260/036; F17C 2260/038; B01F 2003/049; G01F 23/20

(57) ABSTRACT

The present invention is directed generally to the field carbonated beverage dispensing systems having a replaceable carbon dioxide storage cylinder. Such systems may be embodied in the form of a unitary apparatus including, but not exclusively, on-bench, under-bench or freestanding beverage cooling units. The invention may be embodied in the form of a beverage dispensing unit having a gas input connector configured to make gas tight connection to a gas container configured to hold a gas under pressure and a mass detection device. The gas input connector and mass detection device are arranged such that when a gas container is connected to the gas input connector, the mass detection device is capable of detecting a mass associated with the gas container. The unit may further have a gas container support extending from or about the mass detection device configured to maintain a gas container connected to the gas input connector in a position such that it bears on the mass detection device so as to allow the mass detection device to measure the mass of the gas container and any gas contained therein. Computer-implemented methods for monitoring the level of gas are also provided.

### FIELD OF THE INVENTION

The present invention is directed generally to the field carbonated beverage dispensing systems having a replaceable carbon dioxide storage cylinder. Such systems may be embodied in the form of a unitary apparatus including, but not exclusively, on-bench, under-bench or freestanding beverage cooling units.

### BACKGROUND TO THE INVENTION

It is known in the art of carbonated beverage dispensing systems to use a storage cylinder containing carbon dioxide stored under pressure. Gaseous carbon dioxide is drawn from the storage cylinder and contacted with water or other beverage that is dispensed by the dispenser. This arrangement is typical for small scale chilled water dispensers that are used in domestic and office environments. Such dispensers generally comprise a gas-tight water storage tank with an associated heat exchanger which acts to cool water within the tank. The tank is generally connected to the mains water supply which replenishes the tank when chilled water is drawn from the tank by a user. Typically a small head space is left in the upper region of the tank.

Carbon dioxide under pressure is introduced into the tank from the storage cylinder via a gas line. In many types of dispenser, carbonation is effected by spraying water obtained from mains supply through an injector and into the headspace of the tank. The headspace is occupied by high pressure carbon dioxide gas provided by the storage cylinder. The water spray provides a high surface area via which carbon dioxide gas can diffuse and thereby enter solution.

Carbon dioxide pressure with the storage cylinder is relatively high (typically around 70 bar at 30° C.), and accordingly an in-line a pressure regulator is used to lower pressure of the gas entering the storage tank to around 4 bar.

It is generally desired for a dispenser or the gas storage cylinder per se to incorporate some means of monitoring the amount of carbon dioxide remaining in a storage cylinder. Information on the amount of carbon dioxide remaining informs of an impending need to install a fresh storage cylinder into the dispenser. Typically, the cylinder pressure regulator includes two mechanical-type analogue pressure gauges, the first showing pressure inside the cylinder and the second, showing the outlet pressure of the gas leaving the regulator. Either or both gauges may be used to detect a low pressure, and therefore inform of the need to change the gas storage cylinder.

It is a problem in the art that such gauges are often not useful for giving sufficient notice that a gas storage cylinder will be empty and require changing. Consumers often report that pressures displayed by the gauges drop suddenly, and at that point only a small number of carbonated beverage servings may be drawn from the dispenser before the cylinder is completely depleted.

Carbon dioxide cylinders are a relatively expensive consumable item of a chilled water dispenser, and many operators of such dispensers do not typically hold a replacement cylinder on the premises. More often, a replacement cylinder is ordered and delivered to the premises. Of course, there may be a delay of several days until the new cylinder is received and in this time the dispenser is unable to carbonate chilled water. For some dispensers, the gas storage cylinder may be changed by a service technician and so even where a backup cylinder is kept in reserve some time may elapse before the fresh cylinder can be fitted.

It is a further problem in the art that carbon dioxide may inadvertently leak from the storage cylinder of the dispenser into the atmosphere. A leak may be caused by the cylinder being improperly fitted, or due to a failure in a seal, or any other malfunction or equipment failure. Slow leaks are generally difficult to detect even for a technician, and in any event the consumer is unlikely to notice the slow escape of gas. The undesirable result of gas leakage will be that the cylinder requires more regular replacement, this adding to cost and effort in maintaining the chilled water dispenser. This may negatively impact of consumer's general opinion of the water dispenser, with the consumer avoiding that brand of dispenser in future purchasing decisions given the high cost of upkeep.

It is an aspect of the present invention to overcome or ameliorate one of more problems of the prior art to provide improved means for monitoring the level of a gas in a storage cylinder of a beverage dispenser and/or avoid leakage of gas therefrom. It is another aspect to provide an alternative to prior art means for monitoring the level of a gas in a storage cylinder of a beverage dispenser.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a beverage dispensing unit comprising: a gas input connector configured to make gas tight connection to a gas container configured to hold a gas under pressure, and a mass detection device, wherein the gas input connector and mass detection device are arranged such that when a gas container is connected to the gas input connector, the mass detection device is capable of detecting a mass associated with the gas container.

In one embodiment of the first aspect, the mass associated with the gas container is an absolute combined mass of the container and the gas, or a change in the combined mass of the container and the gas over time.

In one embodiment of the first aspect, the beverage dispensing unit comprises a gas container support.

In one embodiment of the first aspect, the gas container support is configured such that gas container is substantially prevented from moving in a non-vertical direction.

In one embodiment of the first aspect, the gas container support is configured to maintain a gas container connected to the gas input connector in a position such that it bears on the mass detection device so as to allow the mass detection device to measure the mass of the gas container and any gas contained therein.

In one embodiment of the first aspect, the gas container support extends upwardly from or about the mass detection device.

In one embodiment of the first aspect, the beverage dispensing unit comprises a flexible line configured to make a gas tight connection between the interior of the gas container and the gas input connector.

In one embodiment of the first aspect, the flexible line is of sufficient length and flexibility so as to allow the gas container to freely move upwardly (when emptying) and downwardly (when filling) so as to bear maximally and minimally upon the mass detection device.

In one embodiment of the first aspect, the mass detection device is configured to provide a mass-related output.

In one embodiment of the first aspect, the mass-related output is a substantially continuously variable mass output.

In one embodiment of the first aspect, the mass detection device is electrical or electronic, and the mass-related output is an electrical or electronic mass-related electrical output signal.

In one embodiment of the first aspect, the mass-related electrical output signal is a digital signal.

In one embodiment of the first aspect, the mass detection device is a weighing device.

In one embodiment of the first aspect, the mass detection device is a load cell.

In one embodiment of the first aspect, the mass detection device comprises an upwardly facing load platform, and wherein the beverage dispensing unit is configured such that a gas container connected to the gas input connector is able to bear on the platform so as to allow the mass detection device to measure the mass of a gas container connected to the gas input connector and any gas contained therein.

In one embodiment of the first aspect, the beverage dispensing unit comprises a processor configured to accept as input the mass-related electrical or electronic output signal of the mass detection device, and to output a human or machine comprehensible signal, data or information pertaining to the mass of a gas container connected to the gas input connector and any gas contained therein, or the level of any gas contained in a gas container connected to the gas input connector.

In one embodiment of the first aspect, the beverage dispensing unit comprises an output device in operable communication with the processor, the output device configured to output human-comprehensible information pertaining to the level of gas in a gas container connected to the gas input connector.

In one embodiment of the first aspect, the beverage dispensing unit comprises electronic memory in operable communication with the processor, the electronic memory configured to record (i) a plurality of the mass-related electrical or electronic output signals over time, (ii) a plurality of data packets over time, or (iii) a plurality of information pertaining to the level of gas in a gas container connected to the gas input connector over time.

In one embodiment of the first aspect, the beverage dispensing unit comprises processor-executable software stored in the electronic memory, the processor executable software configured to execute an algorithm for the analysis of the recorded (i) plurality of mass-related electrical or electronic output signals over time, or (ii) the plurality of data packets over time, or (iii) the plurality of information pertaining to the level of gas in the gas container over time.

In one embodiment of the first aspect, the processor executable software is configured to calculate a rate of decrease in the level of a gas in a gas container connected to the gas input connector, and to trigger an alert where the rate is equal to or greater than a predetermined rate, less than a predetermined rate, or within a predetermined rate range, or outside a predetermined weight range.

In one embodiment of the first aspect, the processor executable software is configured to monitor the level of gas in a gas storage container connected to the gas input connector, and to trigger an alert where the level of gas in the storage container is equal to or less that a predetermined level.

In one embodiment of the first aspect, the beverage dispensing unit comprises computer networking means in operable communication with the processor, the computer networking means configurable to allow data communication between beverage dispensing unit and a remote computer.

In one embodiment of the first aspect, the beverage dispensing unit comprises a gas container, wherein the gas container is in gaseous connection with the gas input connector.

In one embodiment of the first aspect, the gas container contains carbon dioxide under pressure.

In a second aspect, the present invention provides a computer-implemented method for determining a fill parameter of a gas container fitted to a beverage dispensing unit, the method comprising monitoring the mass of a gas container fitted to a beverage dispensing unit by electric or electronic means

In one embodiment of the second aspect, the fill parameter is a gas level parameter.

In one embodiment of the second aspect, the method includes the step of the beverage dispensing unit outputting via software controlled electrical or electronic output means an audible or visual alter when the gas level parameter decreases below a predetermined gas level.

In one embodiment of the second aspect, the beverage dispensing unit comprises a processor, processor-executable software and computer network connection means, the processor executable software configured to transmit to a remote server an electronic order for a replacement filled gas container or an electronic message requesting attendance of a technician capable of fitting a replacement filled gas container to the beverage dispensing unit.

In one embodiment of the second aspect, the method includes the step of the beverage dispensing unit outputting via software controlled electrical or electronic output means an audible or visual alert when the gas level decreases in a manner indicative of a gas leakage.

In one embodiment of the second aspect, the beverage dispensing unit is according to one of the embodiments having a processor.

In a thro aspect, there is provided a computer network comprising the beverage dispensing unit is according to any embodiment having a processor and network communication means in network communication with a remote computer.

### BRIEF DESCRIPTION OF THE DRAWINGS

The various embodiments of the invention shown in each of the drawings are not intended to show complete and operable forms of the invention. Moreover, each of the components of the embodiments of the drawings are not drawn to scale. The components are drawn so as to show functional relationships therebetween. Solid arrowed lines represent the direction of water, while arrowed dashed lines show the direction of data flow.

FIG. 1 shows a schematic diagram of a preferred beverage dispensing unit of the present invention capable of reporting the amount of carbon dioxide remaining in an attached cylinder to a visual output device.

FIG. 2 is computer-generated representation in perspective view of a module capable of both retaining a cylinder in an upright position, and also weighing the cylinder.

FIG. 3 is a computer-generated representation in lateral view of the module of FIG. 1.

FIG. 4 is a computer-generated representation in plan view of the module of FIG. 1, albeit with the vertical support member removed to show the curved recess in which the support member is normally received.

### DETAILED DESCRIPTION OF THE INVENTION

Reference throughout this specification to “one embodiment” or “an embodiment” or similar wording means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

The invention has been described with reference to certain advantages. It is not suggested or represented that each embodiment of the invention have all of the advantages described. Any particular embodiment may have only a single advantage. In some embodiments, the invention may provide no advantage and merely provide a useful alternative to the prior art.

The present invention is predicated at least in part on Applicant's discovery of the technical problem which underlies the difficulty in determining whether or not a carbon dioxide cylinder is approaching empty, and with the timing of such identification providing sufficient advance notice to allow for a replacement cylinder to be ordered and installed.

When supplied in small high pressure cylinders, carbon dioxide is held in liquid phase with a layer of carbon dioxide in gaseous phase gas being present above the liquid. Gaseous carbon dioxide is drawn from the top of the cylinder and passes through a pressure reducing valve attached directly to a threaded connection fixed to the cylinder. The carbon dioxide cylinder includes a male threaded stub outlet which incorporates a spring loaded valve. A pressure regulator device follows, and includes a female threaded inlet, matching the cylinder male thread. Pressure regulator includes a pin located centrally within the inlet thread, which depresses the cylinder valve as the regulator is screwed onto the cylinder.

Typically, the carbon dioxide pressure regulator will include two mechanical type analogue pressure gauges, the first showing carbon dioxide pressure inside the cylinder and the second, showing the outlet pressure of the carbon dioxide gas leaving the regulator. For example, the first gauge may read around 70 bar and the second around 4 bar. Neither of these gauges actually inform as to the quantity of carbon dioxide remaining inside the cylinder.

While the carbon dioxide is held in liquid form, the bottle pressure remains constant until all of the liquid carbon dioxide has passed into the gaseous phase. This only occurs when the carbon dioxide cylinder is almost completely empty. Accordingly, the first gauge will remain at about 70 bar until the cylinder is almost exhausted. It is only from this point in time that the pressure of the remaining gaseous carbon dioxide drops fairly quickly, with this drop being observable by a user by reference to the first gauge.

Because the drop in pressure is only observable when the cylinder is almost empty, the dispensing unit will often stop producing carbonated water before a replacement cylinder has been delivered. To the best of Applicant's knowledge, prior artisans have failed to recognise the true nature of the problem as detailed supra.

Having exercised inventive faculty in discovering the technical problem as outline above, further invention was necessary to provide a technical solution. Applicant proposes departure from prior methods that rely on pressure monitoring, and to instead utilize cylinder mass as a physical parameter to provide superior information on the relative emptiness of fullness of a cylinder. By utilizing cylinder mass, the total amount of carbon dioxide (irrespective of whether it is in the gaseous or liquid phase) can be continuously monitored from the time that a fresh cylinder is installed. Having now the ability to monitor the mass of the cylinder, it will be apparent when the amount of carbon dioxide is sufficiently low so as to require an order to be placed for a replacement cylinder. For example, a user may order a replacement cylinder when the amount of carbon dioxide falls to a level below 20%. Based on established usage patterns, the user may know that around two weeks of supply of gas remains in the cylinder, that providing more than sufficient time to order and receive a replacement cylinder.

The carbon dioxide cylinder may be mounted within or on the beverage dispensing unit, and thereby become a functional part of the unit. The cylinder may alternatively be mounted clear of the beverage dispensing unit, but nevertheless is to be considered as a part of the beverage dispensing unit once functionally connected.

As will be clear from the preferred embodiment, the dispensing unit may comprise software capable of inputting cylinder mass as outputted by an electronic load cell (as one type of mass detection means). The software may be configured to automatically monitor cylinder mass (and therefore carbon dioxide usage) over time in order to ascertain the normal rate of use. Based on that rate of normal use, the software may be configured to automatically ascribe an alert level whereby the amount of carbon dioxide remaining is likely to provide supply for another two weeks, or any other prescribed time period within which a replacement cylinder may be reasonably obtained.

A further problem presents in that carbon dioxide cylinders useful in supplying gas to a beverage dispensing unit may present in a range of different tare and gross masses. The problem was that there were several sized cylinders, each having a different tare and gross mass. The gross mass of a carbon dioxide cylinder is typically between about 2 and 2.5×tare mass. Each carbon dioxide cylinder has a certain tare and gross mass rating stamped on the outer surface. Software of the dispenser may be configured to accept input being the tare mass of a replacement cylinder so as to allow for calculation of the mass of carbon dioxide in the cylinder.

As will be appreciated, a beverage dispensing unit capable of producing a carbonated beverage requires a gas input connector to allow for connection of a gas source (such as a gas cylinder). Given that the present invention requires that the cylinder is weighed by a mass detection device (such as a load cell), the gas input connector must be arranged so as to allow the cylinder to freely move in a vertical direction. Movement in a vertical direction is required such that the cylinder, as it is emptied, can move slightly upwardly in response to the upward force exerted by the load cell platform. Thus, the gas input connector will not typically be rigidly fixed to the output of the cylinder. Instead, a flexible line may be used to connect the cylinder to the dispenser. Where a flexible line is used, the gas input connector may be taken as the connector at the terminus of the flexible line, or the connector of dispenser to which the flexible line is attached.

While the gas cylinder is allowed to move slightly along the vertical axis, it is generally desirable to prevent or inhibit non-vertical movement. To avoid any possibility of damage to or malfunction, the cylinder may be retained within a support structure such, as a cradle of some type. The support structure may limit lateral movement of the cylinder base by the provision of a platform having a recess into which the cylinder may sit. The lower faces of cylinders are typically convex-shaped, and so a concavity me be provided on the support structure. To accommodate a range of cylinder diameters, the concavity may have a radius sufficiently large so as to accept the largest expected cylinder diameter. Preferably, the surface upon which the cylinder sits is fabricated from a non-slip material, or is otherwise textured so as to minimise lateral movement of the cylinder.

The support structure may further comprise means to prevent or inhibit lateral movement of the upper region of the cylinder. In one embodiment, a vertical support wall or member is provided to which the cylinder, about its mid region or upper region, may be releasably engaged. The releasable engagement may be provided by any means including a reversible adhesive, a hook-and-loop arrangement, or a clip mechanism, however a generally convenient means is a releasable strap which is configured to retain the cylinder firmly against the vertical wall or member. The strap may be adjustable or elastically stretchable so as to accommodate varying cylinder diameters.

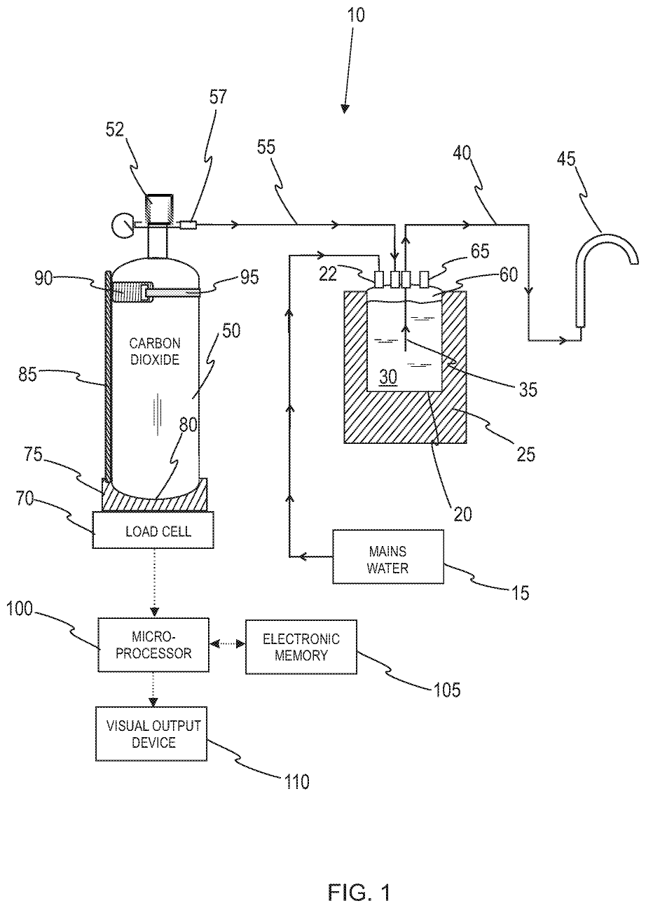

In the preferred embodiment of FIG. 1, the cylinder, platform and vertical support essentially move as one and bear downwardly on the load cell, so as to allow the mass detection device to measure the mass of the gas container and any gas contained therein. In light of such arrangement, it will be appreciated that the mass detection device is preferably capable of being tared or otherwise set or adjusted so as to discount any mass of the support, platform or other non-cylinder hardware.

The mass detection device will typically be a weighing device capable of a continually variable mass output, as further described infra. However, the invention is not so limited and allows for the possibility of various alternatives. For example, the mass detection device may be a simple spring-loaded electrical switch which is triggered (i.e. moved from the open to closed position, or vice versa) when the mass of the cylinder decreases beyond a predetermined level. Triggering of switch may light an indicator on the face of the beverage dispensing unit so as to alert a user to order a replacement cartridge. This approach provides only a binary output, however is nevertheless useful.

As another example, the mass detection device may comprise a fluid-filled bladder, the fluid being in operable connection with a pressure transducer. When the cylinder is heavy (i.e. full of gas) the cylinder exerts a downward force on the bladder, so as to compress the fluid therein, and in turn the transducer outputs a high pressure reading. As the cylinder empties, the pressure of the fluid decreases. Once the fluid pressure is less than a predetermined pressure a similar indicator light may illuminate on the face of the beverage dispensing unit. In this embodiment, no regard is had to any numerical mass (in grams) however a mass detection function is nevertheless provided.

In preferred embodiments the mass detection device is an electric or electronic weighing device, such as a load cell. As described elsewhere herein, the electrical or electronic output of a load cell may be used as a processor input allowing for a variety of automated functions to be executed with no consideration or activity being required on the part of the user. In the context of the present invention, a load cell includes any a transducer that is used to create an electrical or electronic signal whose magnitude is substantially proportional to the load being measured. Various load cell types include hydraulic, pneumatic, and strain gauge. A load cell typically comprises a platform onto which the cylinder is placed, and as described elsewhere herein, the platform may be configured so as to incorporate support means to maintain the cylinder in a generally fixed position.

The mass detection device may be selected according to the size and/or capacity of an expected cylinder or range of cylinders potentially operable with the beverage dispensing unit. A relatively small capacity cylinder will typically be used, with the capacity to hold less than 20, 19, 18, 17, 16, 15, 14, 13, 12, 11, 10, 9, 8, 7, 6 or 5 kg of carbon dioxide. The gross weight of the cylinder will typically be around 2.5 times the gas capacity.

The mass detection device will typically have an electrical or electronic output useful as input for other electrical and electronic components of the beverage dispensing unit. The output may be analogue, such as an electrical signal of variable voltage or variable resistance. Alternatively, the output may be a digital signal encoding a discrete numerical value (such as an integer between 0 and 256). In any event, the output may be directly proportion to the mass of the cylinder under measurement.

The output of the mass detection device may be used as input (directly or indirectly) to an electronic visual display unit which shows a numerical output (such as percentage gas remaining, or grams of the gas remaining, or the estimated number of days remaining until the container must be replaced) or a graphical output (such as a bar that becomes shorter as the gas container empties). Alternatively, a set of line of LEDs may be implemented with the number of lit LEDs decreasing sequentially as the gas container empties.

For stability, the mass detection device is preferably integral with the beverage dispensing unit, or fixed in some manner to the beverage dispensing unit. Accordingly, the mass detection device is preferably provided with fixing means such screw holes, or a bracket having screw holes, or one half of a reciprocal mating means (for example, a clipping, snap-on, or slide-on mechanism). A non-permanent fixing means is preferred to allow for the mass detection device to be removed for servicing, repair or replacement.

In terms of power supply for the mass detection device (where one is required), a suitable voltage may be obtained from an existing power rail of the beverage dispensing unit. Where necessary a step-up or step-down transformer may be disposed in the circuit. Typically, the mass detection device will be electrically connected to the beverage dispensing unit by way of a releasable plug and socket means to allow easy removal of the device form the unit.

Some embodiments of the present beverage dispensing unit comprise a processor with processor-executable software stored in associated electronic memory. Such embodiments provide significant advantage over prior art means of monitoring carbon dioxide levels by analogue gauge means as in the prior art.

One advantage of such embodiments is that the mass detector device output may be monitored over time to detect a gas leakage within the beverage dispensing device. Minor leaks are difficult to detect and indeed often remain undetected resulting in significant wastage of carbon dioxide gas. As discussed elsewhere herein cylinder mass may be monitored over time, such that any loss in mass at an unexpected time, or any loss outside a certain specification may trigger a visual or audio alert to a user. For example, any steady decrease in cylinder mass over an extended period of time (say, 1 hour) would indicate the presence of a gas leak. Typically, carbon dioxide gas is drawn sporadically into the chilled water tank when water is dispensed, and this pattern of mass decrease is distinguishable from a leakage scenario by software-execute algorithmic means. Such embodiments provide significant advantage over prior art means of monitoring carbon dioxide levels by analogue gauge means as in the prior art.

In some embodiments of beverage dispensing units comprising a processor and software, a computer network interface means may be provided so as to be in operable communication with the processor and under the control of the software. For example, a WiFi™ chip may be embedded in the system architecture of the unit, and used to provide connectivity to the Internet. Upon detection of the impending exhaustion of the carbon dioxide cylinder (according to a predetermined cylinder mass, for example, and as described elsewhere herein), the software of the beverage dispensing unit may transmit an electronic order via the Internet to the computer of a predetermined cylinder supplier (typically the vendor or manufacturer of the unit, or a company associated therewith) to dispatch a replacement cylinder to the installation address. Alternatively, the software may transmit an electronic message to the computer of a service company (typically the vendor or manufacturer of the unit, or a company associated therewith) may trigger the dispatch of service personnel to the installation address. By these embodiments, the beverage dispensing device is not necessarily required to output a visual or audio alert for a user to order replacement gas cylinder. Advantageously, the task of monitoring the gas cylinder fill level is no longer necessary for a user. Such embodiments provide significant advantage over prior art means of monitoring carbon dioxide levels by analogue gauge means as in the prior art.

From the above, it will be realised that a further aspect of the present invention resides in an electronic communications network configured to allow communication between a beverage dispensing unit having network interface means, and a second computer (typically a networked computer server), the second computer being owned, administered or controlled by an entity that supplies and/or installs replacement gas cylinders.

As will be understood, the methods and systems described herein may be deployed in part or in whole through one or more processors that execute computer software, program codes, and/or instructions on a processor. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

Any processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of memory, disk, flash drive, RAM, ROM, cache and the like.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Furthermore, the elements depicted in any flow chart or block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The application software may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The invention may be embodied in program instruction set executable on one or more computers. Such instructions sets may include any one or more of the following instruction types:

Data handling and memory operations, which may include an instruction to set a register to a fixed constant value, or copy data from a memory location to a register, or vice-versa, to store the contents of a register, result of a computation, or to retrieve stored data to perform a computation on it later, or to read and write data from hardware devices.

Arithmetic and logic operations, which may include an instruction to add, subtract, multiply, or divide the values of two registers, placing the result in a register, possibly setting one or more condition codes in a status register, to perform bitwise operations, e.g., taking the conjunction and disjunction of corresponding bits in a pair of registers, taking the negation of each bit in a register, or to compare two values in registers (for example, to determine if one is less, or if they are equal).

Control flow operations, which may include an instruction to branch to another location in the program and execute instructions there, conditionally branch to another location if a certain condition holds, indirectly branch to another location, or call another block of code, while saving the location of the next instruction as a point to return to.

Coprocessor instructions, which may include an instruction to load/store data to and from a coprocessor, or exchanging with CPU registers, or perform coprocessor operations.

A processor of a computer of the present system may include “complex” instructions in their instruction set. A single “complex” instruction does something that may take many instructions on other computers. Such instructions are typified by instructions that take multiple steps, control multiple functional units, or otherwise appear on a larger scale than the bulk of simple instructions implemented by the given processor. Some examples of “complex” instructions include: saving many registers on the stack at once, moving large blocks of memory, complicated integer and floating-point arithmetic (sine, cosine, square root, etc.), SIMD instructions, a single instruction performing an operation on many values in parallel, performing an atomic test-and-set instruction or other read-modify-write atomic instruction, and instructions that perform ALU operations with an operand from memory rather than a register.

An instruction may be defined according to its parts. According to more traditional architectures, an instruction includes an opcode that specifies the operation to perform, such as add contents of memory to register—and zero or more operand specifiers, which may specify registers, memory locations, or literal data. The operand specifiers may have addressing modes determining their meaning or may be in fixed fields. In very long instruction word (VLIW) architectures, which include many microcode architectures, multiple simultaneous opcodes and operands are specified in a single instruction.

Some types of instruction sets do not have an opcode field (such as Transport Triggered Architectures (TTA) or the Forth virtual machine), only operand(s). Other unusual “0-operand” instruction sets lack any operand specifier fields, such as some stack machines including NOSC.

Conditional instructions often have a predicate field—several bits that encode the specific condition to cause the operation to be performed rather than not performed. For example, a conditional branch instruction will be executed, and the branch taken, if the condition is true, so that execution proceeds to a different part of the program, and not executed, and the branch not taken, if the condition is false, so that execution continues sequentially. Some instruction sets also have conditional moves, so that the move will be executed, and the data stored in the target location, if the condition is true, and not executed, and the target location not modified, if the condition is false. Similarly, IBM z/Architecture has a conditional store. Some instruction sets include a predicate field in every instruction; this is called branch predication.

The instructions constituting a program are rarely specified using their internal, numeric form (machine code); they may be specified using an assembly language or, more typically, may be generated from programming languages by compilers.

### DESCRIPTION OF THE PREFERRED EMBODIMENTS OF THE DRAWINGS

Reference is now made to FIG. 1, being a highly preferred chilled water dispensing unit (10) of the present invention, of the type capable of dispensing a sparking (carbonated) water to a user. Mains water (15) is used as the source of water for the unit (10), the water being admitted into a storage tank (20) via spray injector (22). A cooling block (25) surrounds the tank (20) to cool the water (30) within the tank. The tank has an outlet tube (35) through which water (30) may pass to conduit (40) and then to the environment via spout (45), typically into the drinking cup (not shown) of a user.

The source of carbon dioxide for the carbonation of the chilled water (30) within the storage tank (20) is the cylinder (50). The cylinder (50) comprises carbon dioxide gas at relatively high pressure (typically around 70 bar) and its output tap (52) is connected by a flexible gas-tight line (55) to the storage tank (20) by way of gas input connector (57). A headspace (60) of gaseous carbon dioxide is maintained in the storage tank (20) typically at a pressure of 3 to 5 bar. Where the pressure exceeds a predetermined level, a pressure relief valve (65) is activated.

Incoming water is sprayed by the injector (22), and given the sprayed water is surrounded by carbon dioxide at pressure within the headspace (60), the gas enters solution into the water. Accordingly, the water (30) in the storage tank (20) is carbonated.

The cylinder (50) sits on a load cell (70) having a platform (75) with a concave upper surface (80) which generally conforms to the lower face of the cylinder (50). By this arrangement the lower region of the cylinder (50) is prevented from lateral movement, and is retained properly so as to fully bear on the mass detection mechanism of the load cell (70). A support member (85) extends upwardly from the platform at 90 degrees, and is positioned relative to the concavity in the platform (75) such that it contacts the lateral face of the cylinder (50).

Toward the upper terminus of the support member (85) are two opposed arms (one marked (90) in the drawing, the second being obscured behind the cylinder (50)). The arms (90) conform to the curvature of the cylinder (50) and provide anchor points for an adjustable strap (95) which acts to retain the upper region of the cylinder against the inner faces of the arms (90) and the support member (85). By this arrangement, the cylinder (50) is virtually immovable laterally, however is nevertheless moveable along its vertical axis relative to the fixed components of the load cell (70). Thus, the platform (75), support member (85), opposed arms (90) and adjustable strap (95) move vertically as one, relative to the fixed (i.e. immovable) components of the load cell (70). By this arrangement, the load cell transducer (not shown) bears the masses of the platform (75), support member (85), opposed arms (90), adjustable strap (95) and cylinder (50). In order to discount the mass of the platform (75), support member (85), opposed arms (90), and adjustable strap (95) the load cell may tare (manually or automatically) before a filled replacement cylinder is connected to the gas input connector (57). Further adjustment may be made (typically by software means) to discount the mass of the cylinder so as to leave only the mass of carbon dioxide being measured. The software means may accept user input detailing the tare mass of the cylinder via user interface (not shown).

The load cell (70) therefore functions so as to measure the mass of the carbon dioxide cylinder (50) so as to provide at least an indication, if not an accurate measurement, of carbon dioxide remaining in the cylinder (50) as the cylinder empties over time into the head space (60) of the tank (20).

The load cell (70) has a variable voltage output which is proportion to the mass of the object bearing on it. The load cell (70) output is used as input for the microprocessor (100), which via software stored in electronic memory (105) is converted to a human comprehensible output (such as a gram amount) as displayed on a visual output device (110) (such as a pixel-based screen). The visual output device is mounted on or about the beverage dispensing unit (10) where it will be visible to a user. In circumstances where the unit (10) is installed in under a bench or in a cupboard, an intermittent audible beep may be emitted from a speaker (not shown) to draw a user's attention to the visual output device.

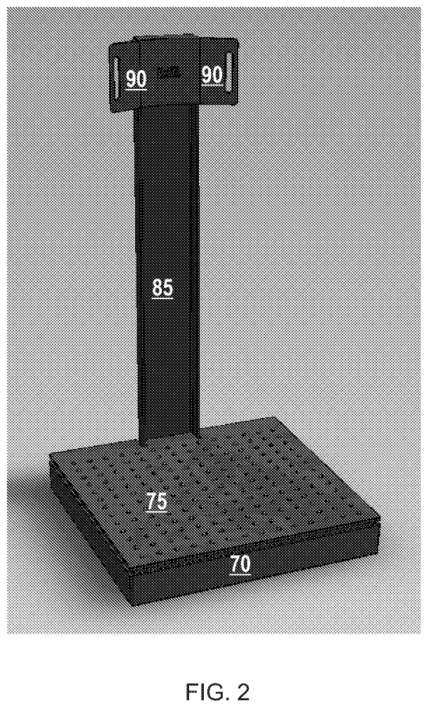

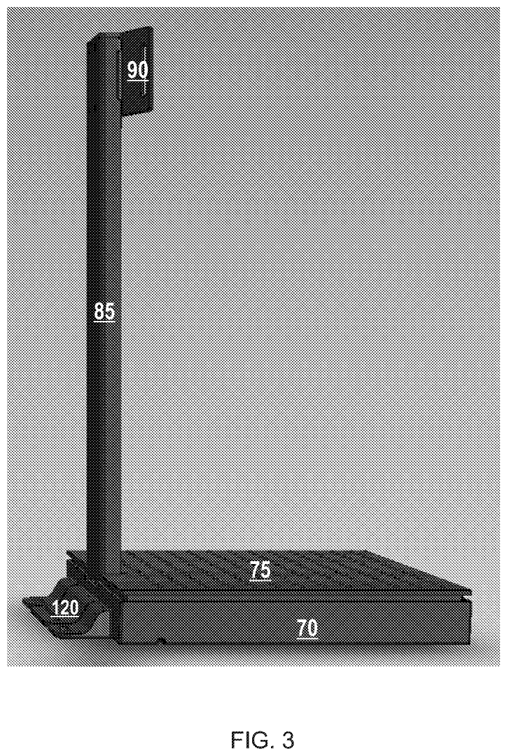

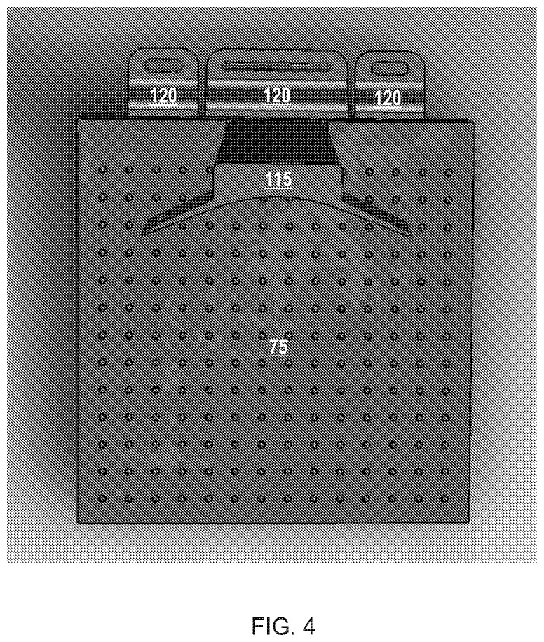

Reference is now made to FIGS. 2, 3 and 4 which show various views of a combined load cell with cylinder support means as applicable for use with a beverage dispensing unit. The components are numbered in accordance with FIG. 1 As shown in FIG. 3 and FIG. 4, attachment tabs (120) are provided which are configured to engage with a reciprocal arrangement on the body of a beverage dispensing device. FIG. 4 shows the recess 115 which receives and retains the lower end of the support member (85) (not shown). The recess (115) is curved in accordance with the curvature of the support member (85).

The present invention has been described in detail in relation to a preferred water dispensing unit. It will be appreciated that the present invention may be applied to liquids other than substantially pure water. For example, any of the water flowing through the present beverage dispensing unit may comprise a flavour (so as to provide a soda-type beverage for example) or a salt (to provide a sparkling mineral-type water for example) or a dietary supplement (to provide a health drink for example) or an alcoholic fluid (to provide a sparkling wine for example).

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A beverage dispensing unit comprising:
a gas input connector configured to make gas tight connection to a gas container configured to hold a gas under pressure, and
a mass detection device,
wherein the gas input connector and mass detection device are arranged such that when a gas container is connected to the gas input connector, the mass detection device is capable of detecting a mass associated with the gas container.

2. The beverage dispensing unit of claim 1, wherein the mass associated with the gas container is an absolute combined mass of the container and the gas, or a change in the combined mass of the container and the gas over time.

3. The beverage dispensing unit of claim 1, comprising a gas container support extending from or about the mass detection device.

4. The beverage dispensing unit of claim 3, wherein the gas container support is configured to maintain a gas container connected to the gas input connector in a position such that it bears on the mass detection device so as to allow the mass detection device to measure the mass of the gas container and any gas contained therein.

5. The beverage dispensing unit of claim 1 comprising a flexible line configured to make a gas tight connection between the interior of the gas container and the gas input connector, wherein the flexible line is of sufficient length and flexibility so as to allow the gas container to freely move upwardly when emptying and downwardly when filling.

6. The beverage dispensing unit of claim 7, wherein the mass detection device is an electrical or electronic device configured to output an electrical or electronic mass-related output signal.

7. The beverage dispensing unit of claim 1, wherein the mass detection device is a load cell.

8. The beverage dispensing unit of claim 1, wherein the mass detection device comprises an upwardly facing load platform, and wherein the beverage dispensing unit is configured such that a gas container connected to the gas input connector is able to bear on the platform so as to allow the mass detection device to measure the mass of a gas container connected to the gas input connector and any gas contained therein.

9. The beverage dispensing unit of claim 6 comprising a processor configured to accept as input the mass-related electrical or electronic output signal of the mass detection device, and to output a human or machine comprehensible signal, data or information pertaining to the mass of a gas container connected to the gas input connector and any gas contained therein, or the level of any gas contained in a gas container connected to the gas input connector.

10. The beverage dispensing unit of claim 9 comprising an output device in operable communication with the processor, the output device configured to output human-comprehensible information pertaining to the level of gas in a gas container connected to the gas input connector.

11. The beverage dispensing unit of claim 9 comprising electronic memory in operable communication with the processor, the electronic memory configured to record (i) a plurality of the mass-related electrical or electronic output signals over time, (ii) a plurality of data packets over time, or (iii) a plurality of information pertaining to the level of gas in a gas container connected to the gas input connector over time.

12. The beverage dispensing unit of claim 11 comprising processor-executable software stored in the electronic memory, the processor executable software configured to execute an algorithm for the analysis of the recorded (i) plurality of mass-related electrical or electronic output signals over time, or (ii) the plurality of data packets over time, or (iii) the plurality of information pertaining to the level of gas in the gas container over time.

13. The beverage dispensing unit of claim 12, wherein the processor executable software is configured to calculate a rate of decrease in the level of a gas in a gas container connected to the gas input connector, and to trigger an alert where the rate is equal to or greater than a predetermined rate, less than a predetermined rate, or within a predetermined rate range, or outside a predetermined weight range.

14. The beverage dispensing unit of claim 12, wherein the processor executable software is configured to monitor the level of gas in a gas storage container connected to the gas input connector, and to trigger an alert where the level of gas in the storage container is equal to or less that a predetermined level.

15. The beverage dispensing unit of claim 9, comprising computer networking means in operable communication with the processor, the computer networking means configurable to allow data communication between beverage dispensing unit and a remote computer.

16. The beverage dispensing unit of claim 1, comprising a gas container, wherein the gas container is in gaseous connection with the gas input connector.

17. A computer-implemented method for determining a fill parameter of a gas container fitted to a beverage dispensing unit, the method comprising, comprising:
providing a beverage dispensing unit comprising a gas input connector configured to make gas tight connection to a gas container configured to hold a gas under pressure, and a mass detection device, wherein the gas input connector and mass detection device are arranged such that when a gas container is connected to the gas input connector, the mass detection device is capable of detecting a mass associated with the gas container, monitoring the mass of a gas container fitted to a beverage dispensing unit by electric or electronic means.

18. (canceled)

19. The computer-implemented method of claim 17, wherein the method includes the step of the beverage dispensing unit outputting via software controlled electrical or electronic output means an audible or visual alert when the fill parameter decreases below a predetermined gas level or when the gas level decreases in a manner indicative of a gas leakage.

20. The computer-implemented method of claim 18, wherein the beverage dispensing unit comprises a processor, processor-executable software and computer network connection means, the processor executable software configured to transmit to a remote server an electronic order for a replacement filled gas container or an electronic message requesting attendance of a technician capable of fitting a replacement filled gas container to the beverage dispensing unit.

21. (canceled)

22. (canceled)

23. A computer network comprising
(i) a beverage dispensing unit comprising:
a gas input connector configured to make gas tight connection to a gas container configured to hold a gas under pressure, and
a mass detection device, wherein the gas input connector and mass detection device are arranged such that when a gas container is connected to the gas input connector, the mass detection device is capable of detecting a mass associated with the gas container,
a processor configured to accept as input the mass-related electrical or electronic output signal of the mass detection device, and to output a human or machine comprehensible signal, data or information pertaining to the mass of a gas container connected to the gas input connector and any gas contained therein, or the level of any gas contained in a gas container connected to the gas input connector, and
computer networking means in operable communication with the processor, the computer networking means configurable to allow data communication between the beverage dispensing unit and a remote computer; and
(ii) a remote computer in network communication with the beverage dispensing unit.
